(19) United States
(12) Patent Application Publication
(10) Pub. No.: US 2020/0379598 A1
(43) Pub. Date: Dec. 3, 2020

(54) APPARATUS CAPABLE OF SENSING TOUCH AND SENSING TOUCH PRESSURE, AND CONTROL METHOD THEREFOR

(71) Applicant: HiDeep Inc., Seongnam-si, Gyeonggi-do (KR)

(72) Inventors: Se Yoeb KIM, Gyeonggi-do (KR); Sam Soo KIM, Gyeonggi-do (KR)

(73) Assignee: HiDeep Inc., Seongnam-si, Gyeonggi-do (KR)

(21) Appl. No.: 16/607,085

(22) PCT Filed: Mar. 21, 2018
(86) PCT No.: PCT/KR2018/003266

§ 371 Date: Oct. 21, 2019

(30) Foreign Application Priority Data
Apr. 20, 2017 (KR) 1020170050815

(51) Int. Cl. G06F 3/041; G06F 3/0488; G06F 3/01; G06F 3/16; H04R 3/04; H04N 5/232

(52) U.S. Cl. CPC G06F 3/0414; G06F 3/04166; G06F 3/04883; H04R 2430/01; G06F 3/16; H04R 3/04; H04N 5/23216; G06F 3/017

(57) ABSTRACT

A device may be provided that includes: a display; a touch sensing unit which senses a touch at a particular position; a pressure sensing unit capable of sensing a magnitude of a pressure at the touched position; and a control unit. The control unit controls an operation of the device in accordance with an input of a user through the touch sensing unit and the pressure sensing unit, and controls the control amount of the device in accordance with a force and swipe gesture or swipe and force gesture. The control amount may be any one of sound volume, a magnification ratio of a current screen, zoom level of an image that is captured in a camera capture mode, a screen brightness, a vibration intensity, a camera focal length, a media play speed, and a scroll speed. According to the embodiment, the operability of the device is enhanced.

### TECHNICAL FIELD

The present disclosure relates to a device capable of touch sensing and touch pressure sensing and a method for controlling the same, and more particularly to a device which is equipped with a touch sensing means and a touch pressure sensing means and is configured to improve user operability of the device by controlling the control amount of the device in response to a pressure touch input, and a method for controlling the same.

### BACKGROUND ART

Various types of input devices are being used to operate a computing system such as smartphones, tablet PCs, laptop computers, navigation devices, KIOSKs, etc. A touch screen (a touch-sensitive display) among various types of input devices is being used increasingly in the computing system due to its easy and simple operability. Further, the laptop computer uses a touch panel, and thus, controls the screen displayed on the monitor or program execution. The use of this touch sensing means makes a user interface simple.

For example, an intuitive interface which uses a touch sensing means is used to enlarge or reduce images on the touch screen. That is, a zoom-in gesture for enlarging the image is generally performed by touching two touch points P1 and P2 on the screen through the use of two fingers (the beginning of the zoom-in gesture), by spreading the two fingers away from each other, and then by releasing the fingers from the screen. The device displays enlarged images in accordance with the zoom-in gesture. That is, from the beginning of the zoom-in gesture to when the finger spreads and stops, the device displays the images while increasing the degree of enlargement in accordance with how much the fingers spread.

However, since the two fingers must be used in the conventional zoom-in gesture, the user have to grip the device with one hand and perform the zoom-in gesture with two fingers of the other hand. Therefore, since both the hands must be used for the zoom-in gesture, when the user holds things with one hand or grips the handle of a subway, etc., it is difficult to perform the zoom-in gesture.

As such, a touch sensitive display which simply senses only the touch has a limit in enhancing user operability. In consideration of this, a device is being developed, which is capable of sensing not only a touch position but also a touch pressure, and many attempts are being made to improve the user operability in such a device. For example, Korean Laid-Open Patent Application No. 10-2015-0068957 discloses that, depending on the magnitude of the user's touch pressure, the zoom level for the geographic starting point and geographic destination is increased and the zoom level of other portions is reduced to reduce the time to load and render map images.

As such, attempts are being made to improve the device operability by using the touch pressure. However, a demand for various operation methods for controlling the device in response to the touch pressure is still not sufficiently satisfied.

### DISCLOSURE

### Technical Problem

A purpose of an embodiment of the present invention is to enhance the operability of a device capable of touch sensing and touch pressure sensing.

Another purpose of the embodiment of the present invention is to provide a user interface capable of performing an operation to control the control amount of the device with one hand in the device capable of touch sensing and touch pressure sensing.

Further another purpose of the embodiment of the present invention is to provide the user interface capable of performing an operation to control the control amount such as sound volume, a magnification ratio of a current screen, zoom level of an image that is captured in a camera capture mode, a screen brightness, a vibration intensity, a camera focal length, a media play speed, a scroll speed, etc., with one hand in the device capable of touch sensing and touch pressure sensing.

Yet another purpose of the embodiment of the present invention is to provide the user interface capable of easily performing an operation to control the sound volume with one hand even without using a separate sound volume control button in the device capable of touch sensing and touch pressure sensing.

Still another purpose of the embodiment of the present invention is to provide the user interface capable of conveniently performing audio-related functions in the device capable of touch sensing and touch pressure sensing.

### Technical Solution

One embodiment is a method including: a pressure touch sensing step of sensing a touch (hereinafter, referred to “pressure touch”) of a pressure greater than a critical pressure at a first touch point; and a control step of controlling a control amount of the device in correspondence with at least any one of a swipe direction and a distance during the swipe gesture when the swipe gesture in which the touch point is moved subsequent to the pressure touch is sensed.

Another embodiment is a method including: a swipe sensing step of sensing a swipe gesture in which a touch point is moved to a second touch point after the touch on a touch screen is sensed at a first touch point; and a control step of controlling a control amount of the device in correspondence with at least any one of a touch time and a pressure which is changed after an initial pressure touch is sensed when a touch of a pressure greater than a critical pressure is sensed at the second touch point subsequent to the swipe gesture. Further another embodiment is a device including: a display; a touch sensing unit which senses a touch at a particular position; a pressure sensing unit capable of sensing a magnitude of a pressure at the touched position; and a control unit. The control unit controls a control amount of the device in accordance with an input of a user through the touch sensing unit and the pressure sensing unit.

The control amount may be any one of sound volume, a magnification ratio of a current screen, zoom level of an image that is captured in a camera capture mode, a screen brightness, a vibration intensity, a camera focal length, a media play speed, and a scroll speed.

### Advantageous Effects

According to the embodiment of the present invention, the functions of the device can be conveniently controlled by using swipe and force gesture or force and swipe gesture, so that the operability of the device is enhanced.

According to the embodiment of the present invention, an operation to control the control amount of the device such as image magnification/reduction, zoom-in/zoom-out of a camera, sound volume control, a media play speed, a vibration intensity, a camera focal length, a scroll speed, etc., can be conveniently performed with one finger.

According to the embodiment of the present invention, since it is possible to control the sound volume even without using a separate sound volume control button, the sound volume control button may be allowed to be removed from the device.

### DESCRIPTION OF DRAWINGS

FIG. 1 is a functional block diagram of a device equipped with a touch screen according to an embodiment of the present invention;

FIG. 2 is a view for describing a force and swipe gesture according to the embodiment of the present invention and shows that an initial swipe direction is upward;

FIG. 3 is a view for describing the force and swipe gesture according to the embodiment of the present invention and shows that the initial swipe direction is downward;

FIG. 4 is a view for describing up and down components and right and left components in the swipe direction;

FIG. 5 shows an example of determining whether the swipe direction is the up and down direction or right and left direction in accordance with absolute values of up and down components in the swipe direction and absolute values of right and left components in the swipe direction;

FIG. 6 shows an example of displaying visually the sound volume which is currently controlled when the sound volume is controlled by the force and swipe gesture;

FIG. 7 is a flowchart for describing the operation of a first embodiment;

FIG. 8 is a view for describing a swipe and force gesture according to the embodiment of the present invention and shows that an initial swipe direction is upward;

FIG. 9 is a view for describing the swipe and force gesture according to the embodiment of the present invention and shows that an initial swipe direction is downward;

FIG. 10 is a view for describing one example of controlling the sound volume in accordance with a change of pressure;

FIG. 11 is a view for describing one example of controlling the sound volume on the basis of the change of pressure and the lapse of touch time; and

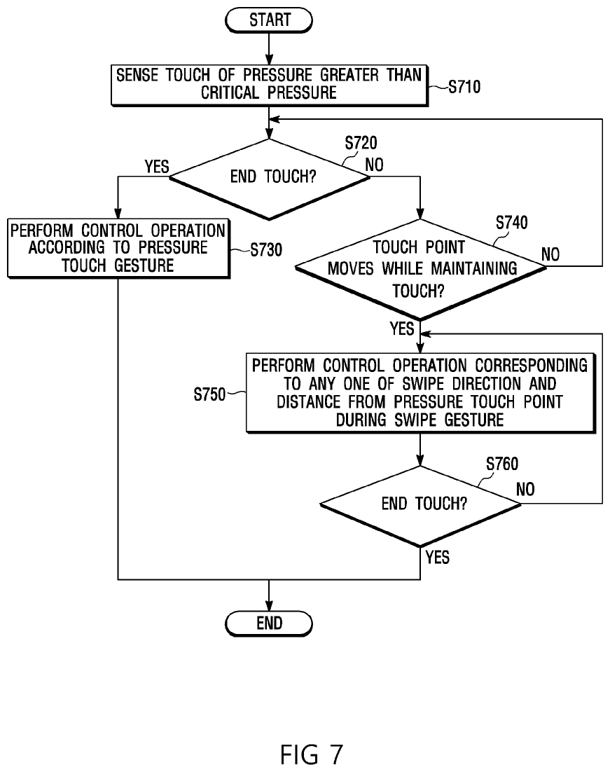

FIG. 7 is a flowchart for describing the operation of a third embodiment.

### MODE FOR INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Here, a device equipped with a touch screen and a method for controlling the same according to an exemplary embodiment of the present invention will be described with reference to the accompanying drawings. The device described in this specification may include a portable phone equipped with a touch screen, a smart phone, a laptop computer, a terminal for digital broadcast, a personal digital assistant (PDA), a navigator, a slate PC, a tablet PC, an ultrabook, wearable devices, KIOSK, etc.

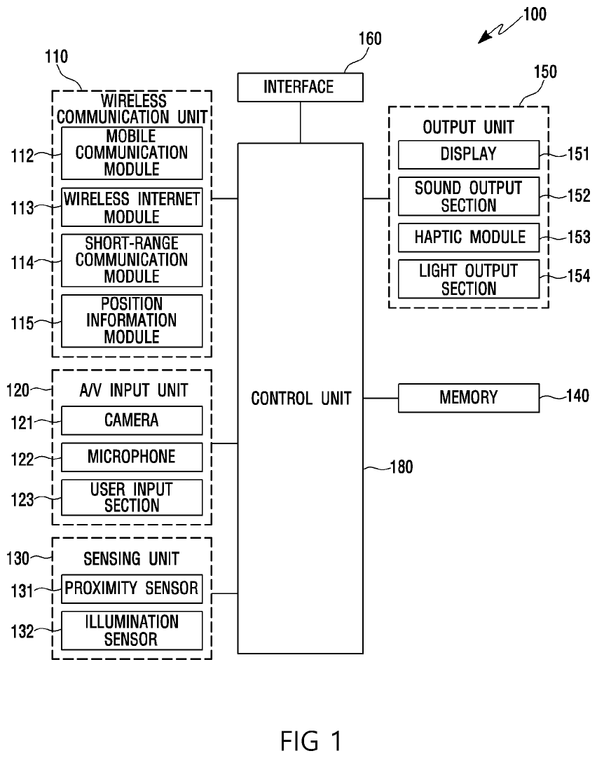

FIG. 1 is a block diagram of the device 100 of one embodiment to which the present invention can be applied, showing an example in which the present invention is applied to a smartphone.

The device 100 may include a wireless communication unit 110, an input unit 120, a sensing unit 130, an output unit 150, an interface 160, a memory 140, a control unit 180, and a power supply 160. The components shown in FIG. 1 are not indispensable in the implementation of the device. The device described in the present specification may have a larger or smaller number of the components than that of the components described above.

The wireless communication unit 110 may include at least one module enabling wireless communication between the device 100 and a wireless communication system, between the device 100 and another device 100, or between the device 100 and an external server. The wireless communication unit 110 may include at least one module which connects the device 100 to at least one network. The wireless communication unit 110 may include at least one of a mobile communication module 112, a wireless internet module 113, a short-range communication module 114, and a position information module 115.

The mobile communication module 112 transmits/receives a radio signal to and from at least one of a base station, an external terminal, and a server in a mobile communication network constructed in accordance with communication methods or technical standards for mobile communication. The wireless internet module 113 refers to a module for wireless internet access and may be built in or externally attached to the device 100.

The wireless internet module 113 transmits/receives a radio signal in a communication network based on wireless internet technologies such as Wireless LAN (WLAN), Wireless-Fidelity (Wi-Fi), etc.

The short-range communication module 114 supports short range communication by using Bluetooth™, Radio Frequency Identification (RFID), Infrared Data Association (IrDA), ZigBee, Near Field Communication (NFC), etc.

The position information module 115 obtains the position (or current position) of the device. A global positioning system (GPS) module or a wireless fidelity (Wi-Fi) module can be taken as a representative example of the position information module 115. However, the position information module 115 is not limited to a module for directly calculating or obtaining the position of the device.

The input unit 120 may include a video input section or a camera 121 for inputting a video signal, an audio input section or a microphone 122 for inputting an audio signal, and a user input section 123 (e.g., a touch key, a mechanical key, etc.) for receiving information of a user. The voice data or image data collected by the input unit 120 may be analyzed and processed as a control instruction of the user.

The camera 121 processes image frames of still images or videos, etc., obtained in a video call mode or in a photographing mode by an image sensor. The processed image frames may be displayed on a display 151 or may be stored in the memory 140.

The microphone 122 processes an external sound signal as an electrical voice data. The processed voice data can be variously used according to the function (or application program being executed) by the device 100.

The user input section 123 receives information from the user. When information is received through the user input section 123, the control unit 180 can control the operation of the device 100 in correspondence to the received information. The user input section 123 may include a mechanical input means (or a mechanical key, for example, a button disposed on the front, rear or side surface of the device 100, a dome switch, a jog wheel, a jog switch, etc.) and a touch-type input means. For example, the touch-type input means may include a virtual key, a soft key, or a visual key displayed on the touch screen through software processing, or may include a touch key disposed on a portion other than the touch screen. Meanwhile, the virtual key or the visual key can have various shapes and be displayed on the touch screen. For example, the virtual key or the visual key may consist of a graphic, a text, an icon, a video, or a combination thereof.

The sensing unit 130 may include at least one sensor for sensing at least one of information on the inside of the device, information on ambient environment surrounding the device, and user information. For example, the sensing unit 130 may include a proximity sensor 131, an illumination sensor 132, a touch sensor, an acceleration sensor, a magnetic sensor, a G-sensor, a gyroscope sensor, a motion sensor, etc.

The output unit 150 generates an output related to a visual sense, an auditory sense, or a tactile sense, etc. The output unit 150 may include at least one of the display 151, a sound output section 152, a haptic module 153, and a light output section 154.

The display 151 may include, for example, a liquid crystal display (LCD), a thin film transistor-liquid crystal display (TFT LCD), an organic light-emitting diode (OLED), a flexible display, a 3D display, an e-ink display, etc. The display 151 can implement the touch screen by forming a mutual layer structure with the touch sensor or by being integrally formed with the touch sensor. The touch screen can function as the user input section 123 providing an input interface between the device 100 and the user and can provide an output interface between the device 100 and the user as well.

In order that the display 151 can receive a control command in a touch manner, the display 151 may include the touch sensor which senses a touch on the display 151. Through this, when a touch occurs on the display 151, the touch sensor senses the touch and the control unit 180 may generate a control command corresponding to the touch on the basis of the touch. The content input in a touch manner may be characters or numbers, instructions in various modes, or a menu item that can be designated. Meanwhile, the touch sensor may be formed in the form of a film having a touch pattern and may be disposed between a window and the display 151 on the back side of the window, or may be composed of a metal wire directly patterned on the back side of the window. According to the embodiment of the present invention, a control unit sensing whether or not the touch occurs and the touch position on the basis of the signal sensed by the touch sensor may be provided in the display 151. In this case, the control unit transmits the sensed touch position to the control unit 180. Alternatively, the display 151 transmits the signal sensed by the touch sensor or a data obtained by converting the signal sensed by the touch sensor into a digital data to the control unit 180. The control unit 180 can determine whether or not the touch has occurred and the touch position.

The sound output section 152 outputs audio signals such as music, voice, etc., and may include a receiver, a speaker, a buzzer, and the like. The haptic module 153 generates various tactile effects that the user can feel. A typical example of the tactile effect generated by the haptic module 153 may be vibration. The light output section 154 outputs a signal notifying the occurrence of an event by using the light of the light source of the device 100. An example of the event that occurs in the device 100 may include message reception, call signal reception, missed call, alarm, schedule notification, email reception, information reception through an application, etc.

The memory 140 stores data supporting various functions of the device 100. The memory 140 may store a plurality of application programs (or applications) executed by the device 100, data for operation of the device 100, and commands. At least some of these application programs may be downloaded from an external server via wireless communication. At least some of these application programs may exist in the device 100 from the time of release of the device 100 for the purpose of basic functions (e.g., call incoming and outgoing, message reception and transmission) of the device 100. Meanwhile, the application program is stored in the memory 140, installed in the device 100, and can be operated by the control unit 180 to perform the operation (or function) of the device.

The control unit 180 typically controls not only the operations related to the application programs, but also the overall operations of the device 100. The control unit 180 processes signals, data, information, etc., input or output through the above-described components, or executes the application programs stored in the memory 140, thereby providing appropriate information or functions to the user. In addition, the control unit 180 can control at least some of the components in order to execute the application programs stored in the memory 140. Further, the control unit 180 can operate the at least two components included in the device 100 in a combination thereof in order to execute the application programs.

The power supply 190 receives an electric power from external and internal power supplies under the control of the control unit 180, and supplies the electric power to each of the components included in the device 100. The power supply 190 may include a battery. The battery may be an embedded battery or a replaceable battery.

At least some of the respective components can operate in cooperation with each other in order to implement the operation, control or control method of the device according to various embodiments to be described below. Also, the operation, control or control method of the device can be implemented in the device by executing at least one application program stored in the memory 140.

Meanwhile, the foregoing has described the example in which the present invention is applied to a smartphone. However, when the present invention is applied to a device that is fixedly installed such as KIOSK, wired communication is applied instead of wireless communication and the camera, microphone, etc., can be changed and applied in such a manner as to be omitted. That is, the components may be appropriately added or omitted depending on the nature of the device to which the present invention is applied.

Further, although FIG. 1 shows that the touch sensor sensing the touch is included in the display 151, some or all embodiments of the present invention can be also applied to a device in which a separate touch panel is provided for sensing the touch and touch pressure, for example, a laptop computer, without including the touch sensor in the display 151. The following description Although the following description mainly describes operations in the device having the touch screen, the embodiments of the present invention can be applied in the same manner to the device having a separate touch panel.

The device 100 can distinguish the types of a touch command on the basis of a pressure. For example, the device 100 may recognize a touch gesture having a pressure less than and not equal to a predetermined pressure as a selection command for a touched area. Then, the device 100 can recognize a touch gesture having a pressure greater than a predetermined pressure as an additional command.

For this, the device 100 includes a pressure sensing unit for sensing the touch pressure. The pressure sensing unit may be integrally coupled to the touch screen or touch panel or may be provided as a separate component. The pressure sensing unit may be provided with a separate controller and may be configured to transmit the sensed pressure value to the controller or may be configured to simply transmit the sensed signal to the controller.

The pressure of the touch gesture can be detected by using various methods. For example, the displayer 151 of the device 100 may include a touch recognition layer capable of sensing a touch and a fingerprint recognition layer capable of sensing a fingerprint. When the user touches by varying the pressure, the image quality of the touched portion may vary. For example, when the user touches the displayer 151 slightly, the touched portion may be recognized as being blurred. On the contrary, when the user touches the displayer 151 by applying a force, the touched portion may be recognized as being clear and dark. Therefore, the displayer 151 including the fingerprint recognition layer can recognize the touched portion by means of the image quality proportional to the touch pressure. The device 100 may detect the intensity of the touched portion according to the image quality.

Alternatively, the strength of the touch pressure can be sensed using a touch area recognized by the device 100. When the user presses lightly the display 151, the area to be touched may be relatively small, and when the user presses strongly, the area to be touched is relatively large. The device 100 can calculate the touch pressure by using a relationship between the area to be touched and the pressure. Therefore, the device 100 can recognize a touch gesture having a pressure higher than a predetermined pressure.

The device 100 may also detect the pressure of the touch gesture by using a piezoelectric element. The piezoelectric element refers to a device which senses a pressure or causes deformation/vibration by using piezoelectric effect. When a particular solid material is subjected to mechanical stress (precisely, mechanical force or pressure) and a deformation occurs, polarization is generated within a certain solid and electric charge is accumulated (accumulate). When a particular solid material receives a mechanical stress (accurately, a mechanical force or pressure) and is deformed, polarization occurs within the solid material and electric charges are accumulated. The accumulated electric charges appear in the form of an electrical signal between both electrodes of the material, that is to say, voltage. This phenomenon is called piezoelectric effect, the solid material is called a piezoelectric material, and the accumulated charge is called piezoelectricity. The device 100 may include a sensing unit (not shown) including a layer made of the piezoelectric material, which can be driven by the piezoelectric effect. The sensing unit can detect applied mechanical energy (force or pressure) and electrical energy (voltage as a kind of an electrical signal) generated by the deformation due to the mechanical energy, and can sense the applied mechanical force or pressure based on the detected voltage.

In another embodiment, the device 100 may include at least three pressures sensors in the pressure sensing unit. The at least three pressures sensors may be arranged in different layers in the display area 151 or arranged in a bezel area. When the user touches the display 151, the pressure sensor can sense the magnitude of the applied pressure. The strength of the pressure sensed by the pressure sensor may be inversely proportional to a distance between the pressure sensor and the touch point of the display 151. The strength of the pressure sensed by the pressure sensor may be proportional to the touch pressure. The device 100 can calculate the touch point and the actual strength of the touch pressure by using the strength of the pressure sensed by each pressure sensor. Alternatively, the device 100 can detect the touch point by including a touch input layer sensing the touch input. The device 100 can also calculate the strength of the touch pressure of the touch point by using the detected touch point and the strength of the pressure sensed by each pressure sensor.

As such, the pressure sensing unit can be configured in various ways. The present invention is not limited to a specific pressure sensing method, and any method capable of directly or indirectly calculating the pressure of the touch point can be applied to the present invention.

Hereinafter, some embodiments of the present invention will be described in detail with reference to the drawings. In the following description, a “pressure touch” means a touch of a pressure greater than a critical pressure, and a “swipe gesture” refers to an operation of moving a touch point while a finger is in touch with the touch screen or the touch panel. According to the embodiment, the “swipe gesture” may be defined as the touch point moving in a state where the touch pressure is less than a predetermined pressure, or may be defined as the touch point moving regardless of the touch pressure. Meanwhile, according to the embodiment, it may also be determined that the swipe gesture is made only when the moving distance of the touch point after the pressure touch is greater than a predetermined distance.

In addition, in the following description, “subsequently” means that the next operation is continued while a finger is in touch with the touch screen or the touch panel. For example, an expression “a pressure touch is performed with one finger and subsequently the swipe gesture is made” means that after a touch of a pressure greater than a critical pressure is performed on the touch screen with one finger, the swipe gesture is made with the finger while maintaining the touch without releasing the finger.

Also, in the following description, the meaning of “a value of B is controlled based on a value of A” is that the value of B is controlled in consideration of the value of A. The value of B is obtained in consideration of the value of A by various methods. For example, the value of B is obtained by multiplying the value of A or a value derived from the value of A (e.g., a differential value, an integral value, etc.) by a predetermined value, the value of B corresponding to the value of A or a value derived from the value of A is stored in advance in a memory in the form of a table, and then the value of B is obtained with reference to the table, the value of B is obtained by using a predetermined calculation formula for calculating the value of B from the value of A, and the value of A or a value derived from the value of A is compared in the program code with predetermined conditions and the value of B is assigned accordingly. The embodiment of the present invention is not limited to a specific method.

The critical pressure may be appropriately set according to devices to which the present invention is applied, fields of application, etc. For example, the critical pressure may be set as a pressure having a fixed magnitude. The magnitude may be appropriately set according to hardware characteristics, software characteristics, etc. Further, the user is also allowed to set the critical pressure.

The swipe direction may be determined as a direction on the display screen, or may be determined based on the gravity direction in consideration of the tilt of the device measured by a tilt sensor.

### First Embodiment

In the first embodiment, when the user applies the pressure touch to the touch screen and then makes the swipe gesture (hereinafter, referred to as force and swipe gesture), the control amount of the device is controlled in correspondence with at least any one of the swipe direction and distance during the swipe gesture. The control amount may be any one of sound volume, a magnification ratio of a current screen, zoom level of an image that is captured in a camera capture mode, a screen brightness, a vibration intensity, a camera focal length, a media play speed, and a scroll speed.

The method according to the embodiment includes a pressure touch sensing step of sensing the pressure touch at a first touch point; and a control step of controlling the control amount of the device in correspondence with at least any one of the swipe direction and distance during the swipe gesture when the swipe gesture in which the touch point is moved subsequent to the pressure touch is sensed.

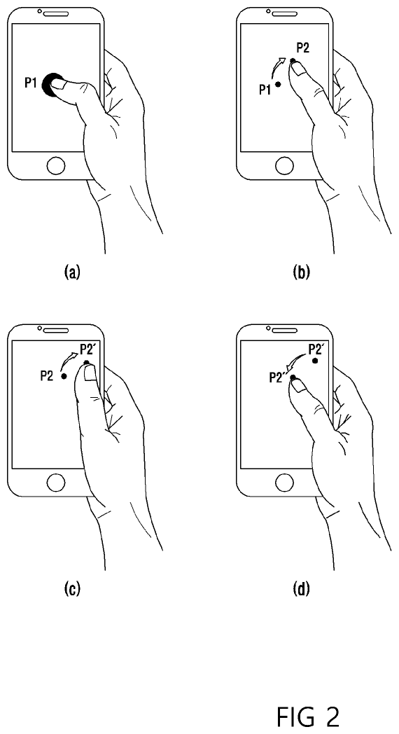

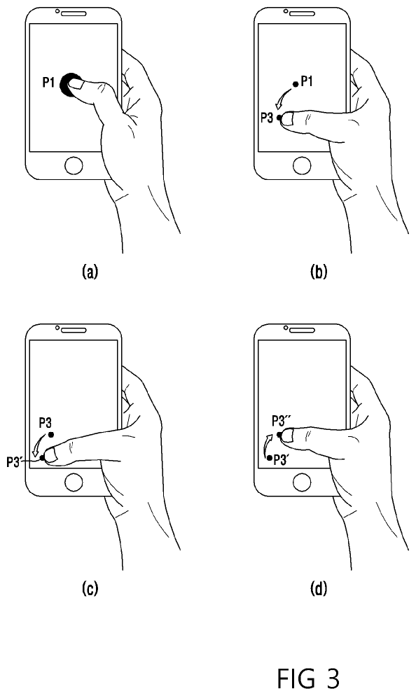

FIG. 2 is a view for describing the force and swipe gesture and shows that an initial swipe direction is upward. FIG. 3 shows that the initial swipe direction is downward.

In (a) of FIG. 2, the user performs the pressure touch at the touch point P1, and then as shown in (b), makes an upward swipe gesture. This operation passes through the touch point P2 and continues to a touch point P2′ as shown in (c), and then continues to a touch point P2″ by changing its direction as shown in (d). The user is able to continue the swipe gesture while moving the touch point until the control is performed as much as the user desires.

FIG. 3 shows that the user performs the pressure touch at the touch point P1, and then as shown in (b), makes a downward swipe gesture. This operation passes through the touch point P3 and continues to a touch point P3′ as shown in (c), and then continues to a touch point P3″ by changing its direction as shown in (d). As with FIG. 2, the user is able to continue the swipe gesture while moving the touch point until the control is performed as much as the user desires.

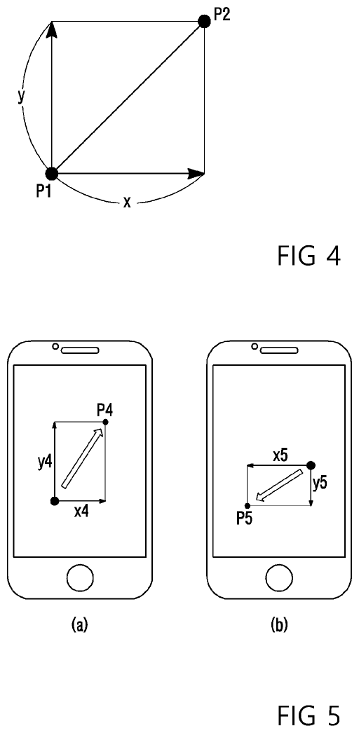

FIGS. 2 and 3 show that the initial direction of the swipe gesture is up and down, respectively. In addition to this, according to the embodiment, even when the initial direction of the swipe gesture is right and left, with the distinction of the right and left initial directions of the swipe gesture, it is possible to configure to perform a control operation accordingly. In the embodiment, the initial direction of the swipe gesture may be determined on the basis of the size of the up and down component and the size of the right and left component of the initial swipe direction. For example, if the swipe gesture is initially, as shown in FIG. 4, made from the touch point P1 to the touch point P2, it is possible to distinguish whether the direction of the swipe gesture is the up and down direction or right and left direction on the basis of the size of the up and down component y and the size of the right and left component x of the swipe direction. In addition, if the size of the up and down component y is larger than the size of the right and left component x, it is possible to distinguish whether the direction of the swipe gesture is up or down on the basis of the size of the sign of the up and down component y.

FIG. 7 is a flowchart for describing the operation of the first embodiment. After the control unit 180 senses a touch of a pressure greater than a critical pressure (step S710) and when the touch ends (YES in step S720), the control unit 180 recognizes this as a pressure touch gesture and performs a predetermined control operation according to the pressure touch in step S730. The control operation according to the pressure touch gesture may be defined for each device and a detailed description thereof is omitted because this does not relate to the present invention. Meanwhile, when the swipe gesture is sensed in which the touch point moves while maintaining the touch after the touch of a pressure greater than a critical pressure is sensed (YES in step S740), the control unit 180 in step S750 performs a control operation corresponding to at least any one of the swipe direction and distance from the pressure touch point during the swipe gesture. The control operation may be an operation to control the control amount of the device. This operation is performed continuously until the touch ends in step S760, that is to say, until the finger which has touched is released from the touch screen.

Next, some examples of the control operation according to the force and swipe gesture will be described.

The control amount may be any one of sound volume, a magnification ratio of a current screen, zoom level of an image that is captured in a camera capture mode, a screen brightness, a vibration intensity, a camera focal length, a media play speed, and a scroll speed. The control amount to be controlled may be determined based on a distance between the touch point where the pressure touch has occurred and the current touch point. For example, in FIG. 2, since the touch point P2′ is farther from the touch point P1 where the pressure touch has occurred than the touch point P2, the control amount at the touch point P2′ is controlled to be larger than the control amount at the touch point P2.

When the direction of the swipe gesture is, as shown in FIG. 2, above the touch point P1, the control amount may be increased based on the distance to the current touch point. When the direction of the swipe gesture is, as shown in FIG. 3, below the touch point P1, the control amount may be decreased based on the distance to the current touch point. Also, during the swipe gesture in one direction, when the direction of the swipe gesture changed into the opposite direction to the one direction, the increase and decrease operations of the control amount can be switched. For example, while the swipe gesture is, as shown in (b) and (c) of FIG. 3, made downward, the control amount is decreased than the current control amount on the basis of the distance from the touch point P1. When the swipe gesture is, as shown in (d) of FIG. 3, switched upward, the control amount is increased again.

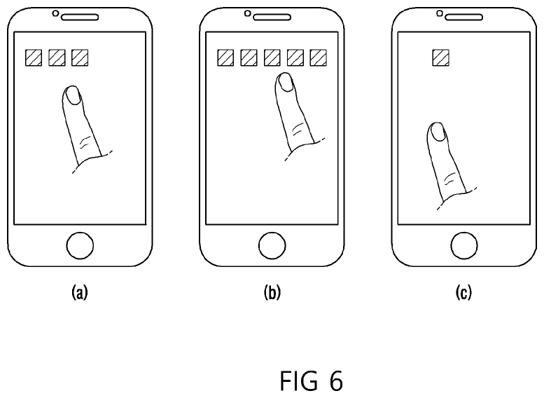

According to the embodiment, the control amount to be controlled may be visually displayed. This is shown in FIG. 6. It can be seen that FIG. 6 visually shows that the upward swipe increases the control amount as shown in (a) and (b) and the downward swipe decreases the control amount as shown in (d).

In the embodiment, when the pressure touch is sensed at the final touch point of the swipe gesture subsequent to the swipe gesture, it is possible to configure that the control amount at this time is set to a default control amount.

In the embodiment, the control amount may be a sound volume.

According to the embodiment, when the absolute value of the up and down component of the initial direction of the swipe after the pressure touch is larger than the absolute value of the right and left component of the initial direction of the swipe, the sound volume is controlled based on the up and down direction and distance. When the absolute value of the right and left component of the initial direction of the swipe after the pressure touch is larger than the absolute value of the up and down component of the initial direction of the swipe, the play speed is controlled based on the right and left direction and distance. For example, when the touch point moves, as shown in (a) of FIG. 5, to a touch point P4 after the pressure touch is performed, the absolute value of the up and down component y4 of the initial direction is larger than the absolute value of the right and left component x4. Therefore, the sound volume is controlled based on the up and down direction and distance. When the touch point moves, as shown in (b) of FIG. 5, to a touch point P5 after the pressure touch is performed, the absolute value of the right and left component x5 is larger than the absolute value of the up and down component y5. Therefore, the play speed is controlled based on the right and left direction and distance. The play speed is controlled based on the right and left direction and distance, which means, for example, the right direction of the swipe gesture increases, on the basis of the distance, the play speed of music which is currently being played, and the left direction of the swipe gesture decreases, on the basis of the distance, the play speed of music which is currently being played.

According to the embodiment, when the up and down component of the initial direction of the swipe after the pressure touch is larger than the right and left component of the initial direction of the swipe, the sound volume is controlled based on the up and down direction and distance. When the right and left component of the initial direction of the swipe after the pressure touch is larger than the up and down component of the initial direction of the swipe, if the initial direction is the left direction, a previous music may be played, and if the initial direction is the right direction, the next music may be played.

According to the embodiment, for example, it is possible to configure that the sound volume is controlled only when the initial swipe direction is upward and other control operations are performed when the initial swipe direction is other directions.

According to the embodiment, the sound volume control operation may be configured such that the volume of the sound which is being output is controlled while the sound is output and an incoming ring volume is controlled while the sound is not output. For example, the volume of the incoming ring is controlled while the incoming ring rings, the sound volume of music which is played is controlled while the music is being played through an earphone, and a call reception sound is controlled during a call.

In another embodiment, the sound volume control operation may be configured such that the volume of the sound which is being output is controlled while the sound is output, the incoming ring volume is controlled in the state where the display is turned on while the sound is not output, and the sound volume control operation is not performed in the state where the display is turned off. Also, the sound volume control operation may be configured such that the volume of the speaker (the earphone if the earphone is connected) is controlled in the state where the display is turned on when the force and swipe gesture is made while the sound is not output. Also, the sound volume control operation may be configured such that the incoming ring volume is controlled regardless of the state of the display when the force and swipe gesture is made while the sound is not output.

In the embodiment, the control operation may be a screen magnification ratio control operation. In this case, the screen magnification ratio to be controlled may be determined based on a distance between the touch point where the pressure touch has occurred and the current touch point. For example, in FIG. 2, since the touch point P2′ is farther from the touch point P1 where the pressure touch has occurred than the touch point P2, the screen magnification ratio at the touch point P2′ is controlled to be larger than the screen magnification ratio at the touch point P2.

According to the embodiment, the screen magnification ratio may be controlled in consideration of the direction of the swipe gesture. For one example, when the direction of the swipe gesture is, as shown in FIG. 2, above the touch point P1, the screen magnification ratio may be increased based on the distance to the current touch point, and when the direction of the swipe gesture is, as shown in FIG. 3, below the touch point P1, the screen magnification ratio may be decreased based on the distance to the current touch point. Also, during the swipe gesture in one direction, when the direction of the swipe gesture changed into the opposite direction to the one direction, the increase and decrease operations of the screen magnification ratio can be switched. For example, while the swipe gesture is, as shown in (b) and (c) of FIG. 3, made downward, the screen magnification ratio is decreased than the current screen magnification ratio on the basis of the distance from the touch point P1. When the swipe gesture is, as shown in (d) of FIG. 3, switched upward, the screen magnification ratio is increased again.

According to the embodiment, the screen magnification ratio to be controlled may be visually displayed. For example, if the current screen magnification ratio is twice, the current screen magnification ratio may be displayed as “x2”, and if the current screen magnification ratio is four times, the current screen magnification ratio may be displayed as “x4”.

In the embodiment, when the pressure touch is sensed subsequent to the swipe gesture at the final touch point of the swipe gesture, it is possible to configure that the screen magnification ratio at this time is set to a default screen magnification ratio. That is, if an application is terminated in this state and started again next time, the screen may be displayed at the set default screen magnification ratio.

In the embodiment, the screen magnification ratio to be controlled may be a screen magnification ratio of an image that is captured in the camera capture mode. That is, it may be possible to configure to control the zoom level by the force and swipe gesture in the camera capture mode.

Meanwhile, in the foregoing description, the number of the pressure touch before the swipe gesture is not limited. However, according to the embodiment, it may be configured to determine that it is a valid force and swipe gesture only when the swipe gesture is made after the pressure touch is performed a predetermined number of times or more than the predetermined number of times while the touch is maintained. For example, after the touch is applied to the first touch point and a pressure greater than a critical pressure is applied, the pressure is reduced below the critical pressure while the touch is maintained, and then the pressure greater than the critical pressure is applied again. In this case, the pressure touch is recognized as being performed twice. According to the embodiment, it may be possible to configure to determine that it is the valid force and swipe gesture only when the swipe gesture is made after the pressure touch is performed once or only when the swipe gesture is made after the pressure touch is performed twice. It may be also possible to configure to perform the control operation corresponding to the number of the pressure touches.

### Second Embodiment

In the second embodiment, when the user applies a pressure greater than the critical pressure while maintaining the touch at the final touch point of the swipe gesture after making the swipe gesture on the touch screen (hereinafter, referred to as swipe and force), the control amount is controlled in correspondence with at least any one of the pressure magnitude and touch time while the pressure changes.

The method of the second embodiment includes a swipe sensing step of sensing a swipe gesture in which a touch point is moved to a second touch point after the touch on the touch screen is sensed at the first touch point, and a control step of controlling the control amount of the device in correspondence with at least any one of the touch time and the pressure which is changed after the initial pressure touch is sensed when the pressure touch is sensed at the second touch point subsequent to the swipe gesture.

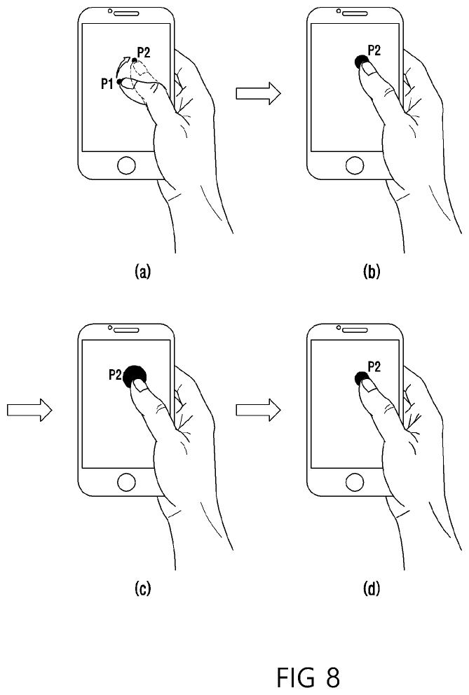

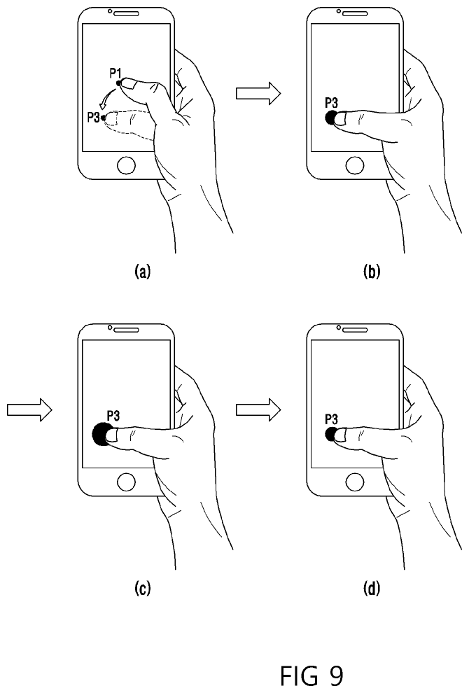

FIG. 8 is a view for describing a swipe and force gesture and shows that the initial swipe direction is upward. FIG. 9 shows that the initial swipe direction is downward.

In (a) of FIG. 8, the user makes the swipe gesture from the touch point P1 to the touch point P2. Without releasing his/her finger after making the swipe gesture, the user presses, as shown in (b), the touch point P2 with a pressure greater than the critical pressure. Then, the user increases, as shown in (c) the pressure or decreases, as shown in (d), the pressure. The user is able to change the pressure at the touch point P2 until the control is performed as much as the user desires.

FIG. 3 shows that the user makes the swipe gesture downward to the touch point P3, and then performs the pressure touch, and changes the pressure. The user makes, as shown in (a), the swipe gesture from the touch point P1 to the touch point P3, and then presses, as shown in (b), the touch point P3 with a pressure greater than the critical pressure without releasing his/her finger after making the swipe gesture. Then, the user increases, as shown in (c) the pressure or decreases, as shown in (d), the pressure. As with FIG. 8, the user is able to change the pressure at the touch point P3 until the control is performed as much as the user desires.

FIGS. 8 and 9 show that the initial direction of the swipe gesture is up and down, respectively. In addition to this, according to the embodiment, even when the initial direction of the swipe gesture is right and left, with the distinction of the right and left initial directions of the swipe gesture, it is possible to configure to perform a control operation accordingly. In the embodiment, the initial direction of the swipe gesture may be determined on the basis of the size of the up and down component and the size of the right and left component of the initial swipe direction. For example, if the swipe gesture is initially, as shown in FIG. 4, made from the touch point P1 to the touch point P2, it is possible to distinguish whether the direction of the swipe gesture is the up and down direction or right and left direction on the basis of the size of the up and down component y and the size of the right and left component x of the swipe direction. In addition, if the size of the right and left component x is larger than the size of the up and down component y, it is possible to distinguish whether the direction of the swipe gesture is right or left on the basis of the size of the sign of the right and left component x.

FIG. 7 is a flowchart for describing the operation of a third embodiment. After the control unit 180 senses the swipe gesture (step S1210) and when the touch ends (YES in step S1220), the control unit 180 recognizes this as a swipe gesture and performs a predetermined control operation according to the swipe gesture in step S1230. A detailed description of the control operation according to the swipe gesture is omitted because it does not relate to the present invention. Meanwhile, when the touch of a pressure greater than a critical pressure is sensed at the final touch point of the swipe gesture while maintaining the touch after the swipe gesture is sensed (YES in step S1240), the control unit 180 in step S1250 performs a control operation corresponding to at least any one of the pressure and touch time while the touch is maintained. The control operation may be an operation to control the control amount of the device. This operation is performed continuously until the touch ends in step S1260, that is to say, until the finger which has touched is released from the touch screen.

Next, some examples of the control operation according to the swipe and force gesture will be described.

The control amount may be any one of sound volume, a magnification ratio of a current screen, zoom level of an image that is captured in a camera capture mode, a screen brightness, a vibration intensity, a camera focal length, a media play speed, and a scroll speed. The control amount to be controlled may be determined based on at least any one of the pressure and touch time.

Hereinafter, an example of the operation of the embodiment will be described with reference to an example of a case where the control amount is a sound volume. The following description relates to the case where the control amount is a sound volume and can be also applied to another kind of the control amount in the same manner.

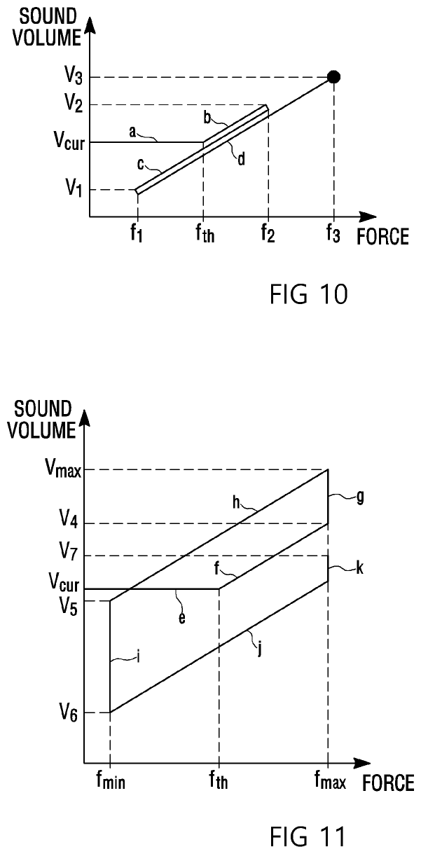

One example of controlling the sound volume in accordance with the pressure change will be described with reference to FIG. 10. In FIG. 10, the x-axis represents the strength of the pressure applied to the touch point P2, and the y-axis represents the magnitude of the sound volume.

Until the pressure applied to the touch point P2 after the swipe operation exceeds a critical pressure fₜₕ, it is not a valid swipe and force gesture. Thus, a currently set sound volume V_{CUR} is maintained as indicated by a line of “a”. If the pressure applied to the touch point P2 exceeds the critical pressure fₜₕ, the sound volume increases in proportion to the pressure as indicated by a line of “b”. If the applied pressure is increased to f₂ and the sound volume is increased to V₂ and then the pressure applied to the touch point P2 is lowered, that is to say, if the user begins to lower the force at which the user presses with his/her finger, the pressure applied to the touch point P2 as indicated by a line of “c” is lowered so that the sound volume is lowered. If the applied pressure is reduced to f₁ and the sound volume is reduced to V₁ and then the pressure applied to the touch point P2 is increased, that is to say, if the user begins to apply more force to the finger, the pressure applied to the touch point P2 as indicated by a line of “d” increases so that the sound volume increases. When the user releases the finger after increasing the sound volume to V₃ by increasing the pressure applied to the touch point P2 to f₃, the sound volume is set to V₃. If the operation shown in FIG. 10 is performed while music is played, while the incoming ring rings, or during a call, the sound volume of the music being played or incoming ring or call voice is controlled along a trajectory shown in FIG. 10 according to the change of the pressure.

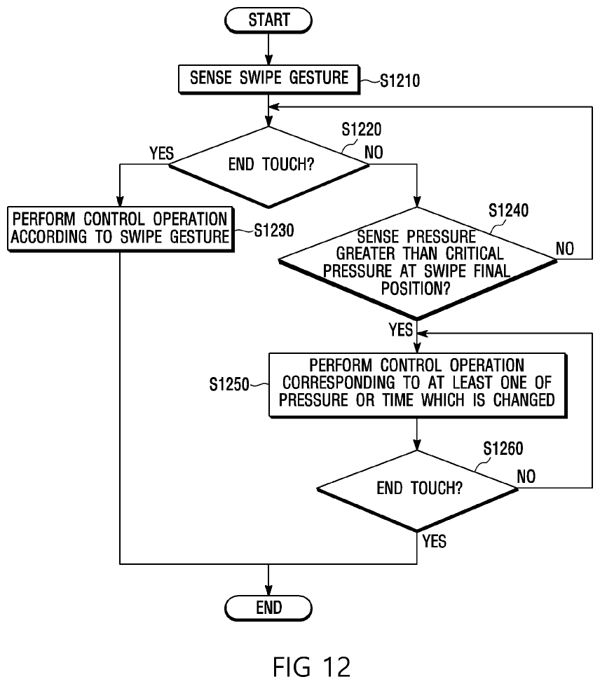

Next, one example of controlling the sound volume on the basis of the pressure change and the lapse of the touch time will be described with reference to FIG. 11. In FIG. 11, the x-axis represents the strength of the pressure applied to the touch point P2, and the y-axis represents the magnitude of the sound volume.

Until the pressure applied to the touch point P2 after the swipe operation exceeds a critical pressure fₜₕ, it is not a valid swipe and force gesture. Thus, a currently set sound volume V_{CUR} is maintained as indicated by a line of “e”. If the pressure applied to the touch point P2 exceeds the critical pressure fₜₕ, the sound volume increases in proportion to the pressure as indicated by a line of “f”. If the applied pressure is increased to the maximum pressure fₘₐₓ and the sound volume is increased to V₄ and then the pressure applied to the touch point P2 is maintained at the maximum pressure, the sound volume continues to increase, as indicated by a line of “g”, in proportion to the time during which the pressure applied to the touch point P2 is maintained at the maximum pressure. After the sound volume reaches the maximum sound volume Vₘₐₓ, the volume does not increase any more even though the pressure applied to the touch point P2 is maintained at the maximum pressure. In this state, when the pressure applied to the touch point P2 is lowered, the volume decreases in proportion to the decrease of the pressure as indicated by a line of “h”. If the pressure applied to the touch point P2 is maintained at the minimum pressure fₘᵢₙ after the applied pressure is reduced to the minimum pressure and the sound volume is reduced to V₅, the sound volume continues to decrease in proportion to the time during which the pressure applied to the touch point P2 is maintained at the minimum pressure as indicated by a line of “i”. If the pressure applied to the touch point P2 is increased after the sound volume decreases to V₆, that is to say, if the user begins to apply more pressure to the finger, the sound volume increases as the pressure applied to the touch point P2 increases, as indicated by a line of “j”. If the user increases the pressure applied to the touch point P2 to the maximum pressure and then maintains the maximum pressure and releases the finger after the sound volume is increased to V₇ as indicated by a line of “k”, the sound volume is set to V₇. If the operation shown in FIG. 11 is performed while music is played, while the incoming ring rings, or during a call, the sound volume of the music being played or incoming ring or call voice is controlled along a trajectory shown in FIG. 11 according to the change of the pressure.

Meanwhile, it has been described in FIG. 11 that the sound volume increases in proportion to the time during which the pressure is maintained at the maximum pressure. Additionally, the sound volume can be also controlled on the basis of the first pressure less than the maximum pressure and the second pressure greater than the minimum pressure instead of the maximum pressure and the minimum pressure. That is, the sound volume is increased based on the pressure until the pressure reaches the first pressure after the initial pressure touch occurs at the second touch point, the sound volume is increased based on the time during which the pressure is maintained above the first pressure after the pressure reaches the first pressure, when the pressure decreases below the first pressure, the sound volume is decreased based on the pressure until the pressure reaches the second pressure lower than the first pressure, and the sound volume is decreased based on the time during which the pressure is maintained below the second pressure after the pressure reaches the second pressure.

Meanwhile, it has been described in FIG. 11 that the sound volume changes in proportion to the change of the pressure as well as the maintenance time. Additionally, the sound volume can be also controlled by using only the maintenance time. That is, the sound volume may be increased while the pressure is maintained above the first pressure after the initial pressure touch occurs at the second touch point, and the sound volume may be decreased while the pressure is maintained below the second pressure. According to the embodiment, the first pressure and the second pressure may be set to be the same as or different from each other.

According to the embodiment, when the absolute value of the up and down component of the initial direction of the swipe is larger than the absolute value of the right and left component of the initial direction of the swipe, the sound volume is controlled based on the up and down direction, the pressure and/or the touch maintenance time. When the absolute value of the right and left component of the initial direction of the swipe is larger than the absolute value of the up and down component of the initial direction of the swipe, the play speed is controlled based on the right and left direction, the pressure and/or the maintenance time. For example, when the pressure touch is performed after the touch point moves, as shown in (a) of FIG. 5, to the touch point P4 is performed, the absolute value of the up and down component y4 of the initial direction is larger than the absolute value of the right and left component x4. Therefore, the sound volume is controlled based on the up and down direction, the pressure and/or the maintenance time. When the pressure touch is performed after the touch point moves, as shown in (b) of FIG. 5, to a touch point P5 after the pressure touch is performed, the absolute value of the right and left component x5 is larger than the absolute value of the up and down component y5. Therefore, the play speed is controlled based on the right and left direction, the pressure and/or the maintenance time. The play speed is controlled based on the right and left direction, the pressure and/or the maintenance time, which means, for example, the right direction of the swipe gesture increases, on the basis of the pressure and/or the maintenance time, the play speed of music which is currently being played, and the left direction of the swipe gesture decreases, on the basis of the pressure and/or the maintenance time, the play speed of music which is currently being played.

According to the embodiment, when the up and down component of the initial direction of the swipe is larger than the right and left component of the initial direction of the swipe, the sound volume is controlled based on the up and down direction and distance. When the right and left component of the initial direction of the swipe is larger than the up and down component of the initial direction of the swipe, if the initial direction is the left direction, a previous music may be played, and if the initial direction is the right direction, the next music may be played.

According to the embodiment, for example, it is possible to configure that the sound volume is controlled only when the initial swipe direction is downward and other control operations are performed when the initial swipe direction is other directions.

According to the embodiment, the sound volume control operation may be configured such that the volume of the sound which is being output is controlled while the sound is output and an incoming ring volume is controlled while the sound is not output. For example, the volume of the incoming ring is controlled while the incoming ring rings, the sound volume of music which is played is controlled while the music is being played through an earphone, and a call reception sound is controlled during a call.

In another embodiment, the sound volume control operation may be configured such that the volume of the sound which is being output is controlled while the sound is output, the incoming ring volume is controlled in the state where the display is turned on while the sound is not output, and the sound volume control operation is not performed in the state where the display is turned off. Also, the sound volume control operation may be configured such that the volume of the speaker (the earphone if the earphone is connected) is controlled in the state where the display is turned on when the force and swipe gesture is made while the sound is not output. Also, the sound volume control operation may be configured such that the incoming ring volume is controlled regardless of the state of the display when the force and swipe gesture is made while the sound is not output.

As with the first embodiment, in the second embodiment, the control amount to be controlled may be visually displayed.

In the embodiment, the control operation may be a screen magnification ratio control operation. That is, when the pressure touch occurs at the second touch point after the swipe gesture is made to the second touch point, the screen magnification ratio is controlled. In this case, the screen magnification ratio to be controlled may be determined based on the pressure and/or the touch maintenance time.

In the embodiment, when the pressure increases after the initial pressure touch occurs at the second touch point, the control unit 180 increases the screen magnification ratio, and when the pressure decreases after the initial pressure touch occurs at the second touch point, the control unit 180 decreases the screen magnification ratio. In another embodiment, while the pressure is maintained above the first pressure after the initial pressure touch occurs at the second touch point, the control unit 180 increases the screen magnification ratio, and while the pressure is maintained below the second pressure after the initial pressure touch occurs at the second touch point, the control unit 180 decreases the screen magnification ratio. In further another embodiment, the control unit 180 increases the screen magnification ratio on the basis of the pressure until the pressure reaches the first pressure after the initial pressure touch occurs at the second touch point, the control unit 180 increases the screen magnification ratio on the basis of the time during which the pressure is maintained above the first pressure after the pressure reaches the first pressure, the control unit 180 decreases the screen magnification ratio on the basis of the pressure until the pressure reaches the second pressure lower than the first pressure when the pressure decreases, and the control unit 180 decreases the screen magnification ratio on the basis of the time during which the pressure is maintained below the second pressure after the pressure reaches the second pressure.

According to the embodiment, the screen magnification ratio may be controlled in consideration of the direction of the swipe gesture. For one example, in a case where the direction of the swipe gesture is above the first touch point, when the pressure increases after the initial pressure touch occurs at the second touch point, the control unit 180 increases the screen magnification ratio, and when the pressure decreases, the control unit 180 decreases the screen magnification ratio. On the contrary, in a case where the direction of the swipe gesture is below the first touch point, when the pressure increases after the initial pressure touch occurs at the second touch point, the control unit 180 decreases the screen magnification ratio, and when the pressure decreases, the control unit 180 increases the screen magnification ratio.

According to the embodiment, the screen magnification ratio to be controlled may be visually displayed. For example, if the current screen magnification ratio is twice, the current screen magnification ratio may be displayed as “x2”, and if the current screen magnification ratio is four times, the current screen magnification ratio may be displayed as “x4”.

In the embodiment, the screen magnification ratio to be controlled may be a screen magnification ratio of an image that is captured in the camera capture mode. That is, it may be possible to configure to control the zoom level by the swipe and force gesture in the camera capture mode.

Meanwhile, in the foregoing description, a pattern of the swipe gesture is not limited. However, according to the embodiment, it may be configured to determine that it is a valid swipe and force gesture only when the pattern of the swipe gesture matches a predefined pattern. For example, it may be configured to determine that it is a valid swipe and force gesture only when the pressure touch occurs after the swipe gesture is made in a shape of “U”. In addition, just like when the pressure touch occurs after the swipe pattern is set to a “V” pattern, the sound volume is controlled, and when the pressure touch occurs after the swipe pattern is set to a “Z” pattern, the screen magnification ratio is controlled, it is also possible to configure to perform corresponding control operations according to the swipe pattern before the pressure touch is performed.

The features, structures and effects and the like described in the embodiments are included in one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

### INDUSTRIAL APPLICABILITY

According to the embodiment of the present invention, the functions of the device can be conveniently controlled by using swipe and force gesture or force and swipe gesture, so that the operability of the device is enhanced.

According to the embodiment of the present invention, an operation to control the control amount of the device such as image magnification/reduction, zoom-in/zoom-out of a camera, sound volume control, a media play speed, a vibration intensity, a camera focal length, a scroll speed, etc., can be conveniently performed with one finger.

According to the embodiment of the present invention, since it is possible to control the sound volume even without using a separate sound volume control button, the sound volume control button may be allowed to be removed from the device.

1. A controlling method in a device capable of touch sensing and touch pressure sensing, the controlling method comprising:
a pressure touch sensing step of sensing a touch (hereinafter, referred to “pressure touch”) of a pressure greater than a critical pressure at a first touch point; and
a control step of controlling a control amount of the device in correspondence with at least any one of a swipe direction and a distance during the swipe gesture when the swipe gesture in which the touch point is moved subsequent to the pressure touch is sensed.

2. The controlling method of claim 1, wherein the control amount to be controlled is determined based on a distance between the first touch point and a current touch point.

3. The controlling method of claim 2, wherein, when a direction of the swipe gesture is above the first touch point, the control amount is increased based on the distance between the first touch point and the current touch point, and wherein, when the direction of the swipe gesture is above the first touch point, the control amount is decreased based on the distance between the first touch point and the current touch point.

4. The controlling method of claim 3, wherein, during the swipe gesture, when the direction of the swipe gesture changed into the opposite direction, increase and decrease operations of the control amount is switched.

5. The controlling method of claim 1, wherein the direction of the swipe gesture is determined based on the gravity direction in consideration of a tilt of the device measured by a tilt sensor.

6. The controlling method of claim 1, further comprising visually displaying the control amount to be controlled.

7. The controlling method of claim 1, wherein, when the pressure touch is sensed at the second touch point subsequent to the swipe gesture to the second touch point, the control amount at the second touch point is set to a default control amount.

8. The controlling method of claim 1, wherein the control amount is a sound volume.

9. The controlling method of claim 8, wherein, when an absolute value of the up and down component of an initial direction of the swipe after the pressure touch is larger than an absolute value of the right and left component of the initial direction of the swipe, the sound volume is controlled based on the up and down direction and distance, and wherein, when the absolute value of the right and left component of the initial direction of the swipe after the pressure touch is larger than the absolute value of the up and down component of the initial direction of the swipe, a play speed is controlled based on the right and left direction and distance.

10. The controlling method of claim 8, wherein, when an absolute value of the up and down component of an initial direction of the swipe after the pressure touch is larger than an absolute value of the right and left component of the initial direction of the swipe, the sound volume is controlled based on the up and down direction and distance, and wherein, when the absolute value of the right and left component of the initial direction of the swipe after the pressure touch is larger than the absolute value of the up and down component of the initial direction of the swipe, if the initial direction is the left direction, a previous music is played, and if the initial direction is the right direction, the next music is played.

11. The controlling method of claim 8, wherein the control amount is the volume of the sound which is being output while the sound is output, and is an incoming ring volume while the sound is not output.

12. The controlling method of claim 8, wherein the control amount is the volume of the sound which is being output while the sound is output, and is an incoming ring volume in a state where a display is turned on while the sound is not output, and wherein the control step is not performed in a state where the display is turned off.

13. The controlling method of claim 1, wherein the control amount is any one of sound volume, a magnification ratio of a current screen, zoom level of an image that is captured in a camera capture mode, a screen brightness, a vibration intensity, a camera focal length, a media play speed, and a scroll speed.

14. The controlling method of claim 1, wherein, when the pressure touch before the swipe gesture is sensed more than a predetermined number of times, the control step is performed.

15. The controlling method of claim 1, wherein a user is allowed to set the critical pressure.

16. A controlling method in a device capable of touch sensing and touch pressure sensing, the controlling method comprising:
a swipe sensing step of sensing a swipe gesture in which a touch point is moved to a second touch point after the touch on a touch screen is sensed at a first touch point; and
a control step of controlling a control amount of the device in correspondence with at least any one of a touch time and a pressure which is changed after an initial pressure touch is sensed when a touch (hereinafter, referred to “pressure touch”) of a pressure greater than a critical pressure is sensed at the second touch point subsequent to the swipe gesture.

17. The controlling method of claim 16, wherein, in the control step, when the pressure increases after the initial pressure touch occurs at the second touch point, the control amount is increased, and when the pressure decreases, the control amount is decreased.

18. The controlling method of claim 16, wherein, in the control step, the control amount is increased while the pressure is maintained above a first pressure after the initial pressure touch occurs at the second touch point, and the control amount is decreased while the pressure is maintained below a second pressure.

19. The controlling method of claim 16, wherein, in the control step, the control amount is increased based on the pressure until the pressure increases and reaches a first pressure after the initial pressure touch occurs at the second touch point, the control amount is increased based on the time during which the pressure is maintained above the first pressure after the pressure reaches the first pressure, when the pressure decreases below the first pressure, the control amount is decreased based on the pressure until the pressure reaches a second pressure lower than the first pressure, and the control amount is decreased based on the time during which the pressure is maintained below the second pressure after the pressure reaches the second pressure.

20. The controlling method of claim 16, wherein, in the control step, when in a case where a direction of the swipe gesture is above the first touch point, when the pressure increases after the initial pressure touch occurs at the second touch point, the control amount is increased, and when the pressure decreases, the control amount is decreased, and in a case where the direction of the swipe gesture is below the first touch point, when the pressure increases after the initial pressure touch occurs at the second touch point, the control amount is decreased, and when the pressure decreases, the control amount is increased.

21. The controlling method of claim 16, wherein the direction of the swipe gesture is determined based on the gravity direction in consideration of a tilt of the device measured by a tilt sensor.

22. The controlling method of claim 16, further comprising visually displaying the control amount to be controlled.

23. The controlling method of claim 16, wherein the control amount is a sound volume.

24. The controlling method of claim 16, wherein, when an absolute value of the up and down component of an initial direction of the swipe gesture is larger than an absolute value of the right and left component of the initial direction of the swipe, the control amount is a sound volume, and when the absolute value of the right and left component of the initial direction of the swipe gesture is larger than the absolute value of the up and down component of the initial direction of the swipe gesture, the control amount is a play speed.

25. The controlling method of claim 16, wherein, when an absolute value of the up and down component of an initial direction of the swipe gesture is larger than an absolute value of the right and left component of the initial direction of the swipe, the control amount is a sound volume, and when the absolute value of the right and left component of the initial direction of the swipe gesture is larger than the absolute value of the up and down component of the initial direction of the swipe gesture, the control step selects a previous music if the initial direction is the left direction, and the control step selects the next music if the initial direction is the right direction.

26. The controlling method of claim 25, wherein, in the selection of the previous or next music, when the pressure falls below a predetermined pressure from above the critical pressure and then the pressure touch is sensed again (hereinafter, referred to as “repressure touch”), the selection of the previous or next music is performed as many times as the repressure touch.

27. The controlling method of claim 23, wherein the control amount is the volume of the sound which is being output while the sound is output, and is an incoming ring volume while the sound is not output.

28. The controlling method of claim 16, wherein the control amount is any one of sound volume, a magnification ratio of a current screen, zoom level of an image that is captured in a camera capture mode, a screen brightness, a vibration intensity, a camera focal length, a media play speed, and a scroll speed.

29. The controlling method of claim 16, wherein, when a pattern of the swipe gesture matches a predefined pattern, the control operation is performed.

30. The controlling method of claim 16, wherein a user is allowed to set the critical pressure.

31. A device comprising:
a display;
a touch sensing unit which senses a touch at a particular position;
a pressure sensing unit capable of sensing a magnitude of a pressure at the touched position; and
a control unit which controls an operation of the device in accordance with an input of a user through the touch sensing unit and the pressure sensing unit, and controls a control amount of the device in correspondence with at least any one of a swipe direction and a distance during a swipe gesture when a touch (hereinafter, referred to “pressure touch”) of a pressure greater than a critical pressure is sensed and the swipe gesture in which a touch point is moved subsequent to the pressure touch is sensed.

32. A device comprising:
a display;
a touch sensing unit which senses a touch at a particular position;
a pressure sensing unit capable of sensing a magnitude of a pressure at the touched position; and
a control unit which controls an operation of the device in accordance with an input of a user through the touch sensing unit and the pressure sensing unit, and controls a control amount of the device in correspondence with at least any one of a touch time and a pressure which is changed after an initial pressure touch is sensed, when a swipe gesture in which a touch point is moved to a second touch point after the touch on a touch screen is sensed at a first touch point is sensed and then when the pressure touch is sensed at the second touch point.

33. The device of claim 31, wherein the control amount is any one of sound volume, a magnification ratio of a current screen, zoom level of an image that is captured in a camera capture mode, a screen brightness, a vibration intensity, a camera focal length, a media play speed, and a scroll speed.
